(19) United States
(12) Patent Application Publication
(10) Pub. No.: US 2025/0276475 A1
(43) Pub. Date: Sep. 4, 2025

(54) INJECTION MOLDING MACHINE

(71) Applicant: SEIKO EPSON CORPORATION, Tokyo (JP)

(72) Inventor: Masayuki TAKAHASHI, Shiojiri (JP)

(21) Appl. No.: 19/064,787

(22) Filed: Feb. 27, 2025

(30) Foreign Application Priority Data
Mar. 1, 2024 (JP) 2024-031376

(51) Int. Cl. B29C 45/03; B29C 45/00; B29C 45/74; B29C 45/77; B29C 45/78; B29K 101/12

(52) U.S. Cl. CPC B29C 45/03; B29C 45/74; B29C 45/77; B29C 45/78; B29C 2045/0051; B29C 2945/76006; B29C 2945/7604; B29C 2945/76531; B29C 2945/76545; B29C 2945/76658; B29K 2101/12

(57) ABSTRACT

There is provided an injection molding machine including a material supply unit configured to supply a shaping material including plasticized thermoplastic resin, an injection unit including a manifold including a main flow path communicating with the material supply unit and a plurality of branch flow paths branching from the main flow path and a plurality of nozzles respectively coupled to the branch flow paths and configured to inject the shaping material to a die unit, a positioning unit configured to position the injection unit and the die unit, and a control unit configured to control operation of the material supply unit and the injection unit. The manifold includes a first member and a second member that are bodies separate from each other and can be assembled and separated, and the branch flow paths are formed in a boundary portion of the first member and the second member in an assembled state of the first member and the second member.

The present application is based on, and claims priority from JP Application Serial Number 2024-031376, filed Mar. 1, 2024, the disclosure of which is hereby incorporated by reference herein in its entirety.

### BACKGROUND

### 1. Technical Field

The present disclosure relates to an injection molding machine.

### 2. Related Art

There has been known an injection molding apparatus that injects a resin material such as plasticized thermoplastic resin from a nozzle into a cavity formed in a die to manufacture a resin molded product.

For example, JP-A-5-305625 discloses an injection molding apparatus including a supply unit that supplies heated resin, a manifold coupled to the supply unit and including an internal flow path, and a nozzle coupled to the manifold and communicating with the internal flow path.

JP-A-5-305625 is an example of the related art.

In an injection molding apparatus disclosed in JP-A-5-305625, a plurality of internal flow paths of the manifold are provided and each have a relatively small inner diameter. As explained above, since the structure of the internal flow path of the manifold is complicated and a main portion of the manifold is configured by a single member, it is difficult to perform maintenance, for example, cleaning of the internal flow path. If the maintenance is not satisfactorily performed, it is likely that a defect such as clogging occurring in a part of the internal flow path and hindering a flow of melted resin occurs, causing deterioration in molding quality in injection molding.

### SUMMARY

According to an aspect of the present disclosure, there is provided an injection molding machine including:
a material supply unit configured to supply a shaping material including plasticized thermoplastic resin;
an injection unit including a manifold including a main flow path communicating with the material supply unit and a plurality of branch flow paths branching from the main flow path, and a plurality of nozzles respectively coupled to the branch flow paths and configured to inject the shaping material to a die unit;
positioning unit configured to position the injection unit and the die unit; and
a control unit configured to control operation of the material supply unit and the injection unit, wherein
the manifold includes a first member and a second member that are bodies separate from each other and can be assembled and separated, and
the branch flow paths are formed in a boundary portion of the first member and the second member in an assembled state of the first member and the second member.

### BRIEF DESCRIPTION OF THE DRAWINGS

FIG. 1 is a cross-sectional view illustrating a schematic configuration of an injection molding machine according to an embodiment of the present disclosure.

FIG. 2 is a top view of an injection unit provided in the injection molding machine illustrated in FIG. 1 as viewed from above.

FIG. 3 is a cross-sectional view taken along a line A-A in FIG. 2.

FIG. 4 is a cross-sectional view illustrating a state in which a first member and a second member illustrated in FIG. 3 are separated.

An injection molding machine of the present disclosure is explained in detail below based on an embodiment illustrated in the accompanying drawings.

### FIRST EMBODIMENT

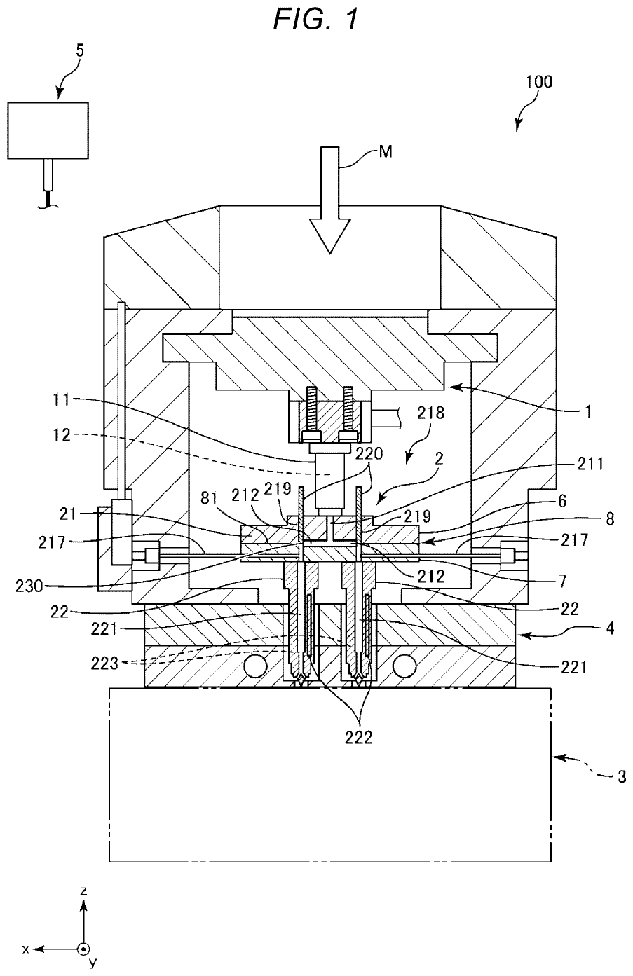

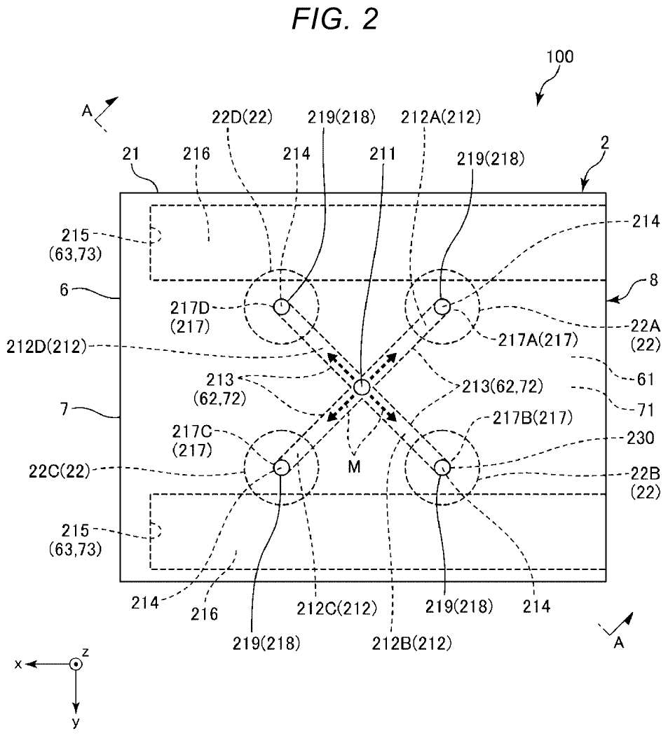

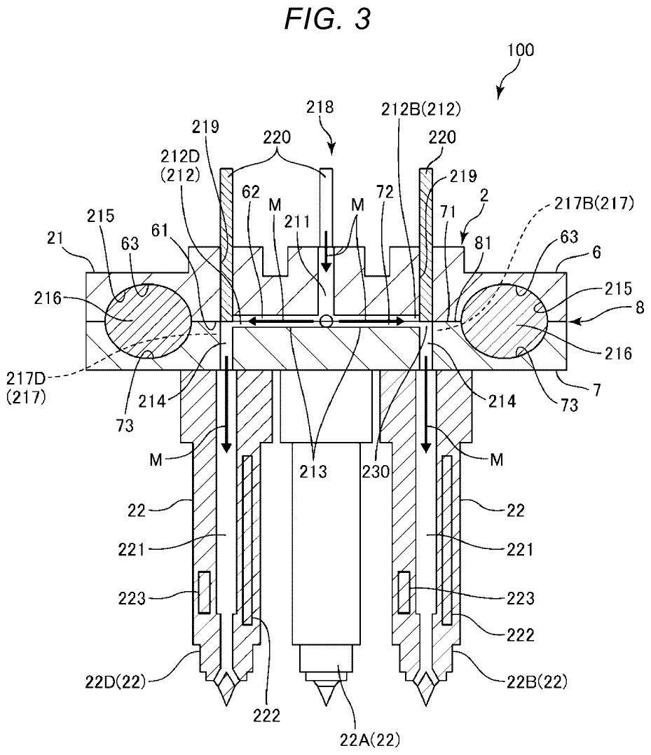

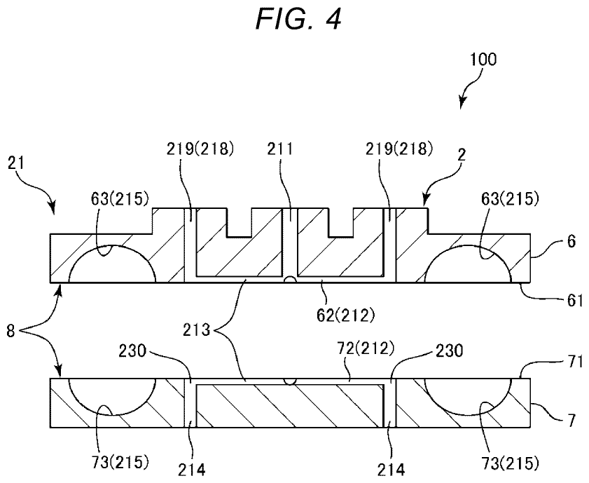

FIG. 1 is a cross-sectional view illustrating a schematic configuration of an injection molding machine according to an embodiment of the present disclosure. FIG. 2 is a top view of an injection unit of the injection molding machine illustrated in FIG. 1 as viewed from above. FIG. 3 is a cross-sectional view taken along a line A-A in FIG. 2. FIG. 4 is a cross-sectional view illustrating a state in which a first member and a second member illustrated in FIG. 3 are separated (sometimes simply referred to as “separated state” below).

An up-down direction in FIG. 1 coincides with the vertical direction. The upper side in FIGS. 1, 3, and 4 is also referred to as “upper” and the lower side in FIGS. 1, 3, is also referred to as “lower”.

In FIGS. 1 and 2, an x axis, a y axis, and a z axis orthogonal to one another are illustrated. In the axes, a direction pointed by an arrow is a “+ side” and the opposite side is a “− side”. The z axis coincides with the vertical direction, and the x axis and the y axis are parallel to the horizontal direction.

In the present specification, “vertical” means not only coinciding with the vertical but also inclining slightly, for example, within ±10° with respect to the vertical. In the present specification, “parallel” means not only two objects coinciding with the parallel but also the two objects inclining slightly, for example, within ±10° from the parallel.

An injection molding machine 100 illustrated in FIG. 1 includes a material supply unit 1, an injection unit 2, a die unit 3, a positioning unit 4, and a control unit 5. The material supply unit 1, the injection unit 2, and the die unit 3 are arranged in this order from the upper side to the lower side in FIG. 1.

The material supply unit 1 supplies a shaping material M containing plasticized resin to the injection unit 2. The plasticized shaping material M includes, for example, thermoplastic resin melted and softened by heating. The material supply unit 1 includes, for example, a not-illustrated plasticizing unit that heats and plasticizes pellet-shaped or powder-shaped solid resin.

Examples of the thermoplastic resin include polyolefin such as AS resin, ABS resin, polyethylene, polypropylene, and ethylene-vinyl acetate copolymer (EVA); acrylic resin such as modified polyolefin and polymethyl methacrylate; polyester such as polyvinyl chloride, polystyrene, polyethylene terephthalate and polybutylene terephthalate; polyamide (nylon: registered trademark) such as nylon 6, nylon 46, nylon 66, nylon 610, nylon 612, nylon 11, nylon 12, nylon 6-12, and nylon 6-66; liquid crystal polymers such as polyphenylene ether, polyacetal, polyether, polyphenylene oxide, polyetheretherketone, polycarbonate, polyphenylene sulfide, thermoplastic polyimide, polyetherimide, and aromatic polyester; and various thermoplastic elastomers such as styrene, polyolefin, polyvinyl chloride, polyurethane, polyester, polyamide, polybutadiene, trans-polyisoprene, fluororubber, and chlorinated polyethylene. One kind or two or more kinds selected out of the above can be used or can be used in combination.

The shaping material M may include, for example, powder of various metal materials, various alloys, and the like.

A melting temperature and a softening temperature of the shaping material M are not particularly limited. The temperature of the plasticized shaping material M, in particular, the temperature of the melted shaping material M is, for example, approximately 50° C. or higher and 350° C. or lower depending on a composition of the shaping material M.

Plasticization mainly indicates plasticization by heating, is a concept including glass transition, softening, and melting, and means changing a solid into a state having fluidity. Specifically, in the case of a material in which glass transition occurs, “plasticization” means setting the temperature of the material to temperature equal to or higher than a glass transition point. In the case of a material in which glass transition does not occur, the plasticization means setting the temperature of the material to temperature equal to or higher than a softening point, or equal to or higher than a melting point.

The material supply unit 1 includes a supply nozzle 11 extending in the z-axis direction. The supply nozzle 11 includes, on the inside, a supply flow path 12 extending in the z-axis direction. The shaping material M is supplied to the injection unit 2 via the supply flow path 12.

In the supply flow path 12, means for promoting transfer and supply of the shaping material M such as a screw, a feeder, and a pressing portion not illustrated in the figure may be provided.

The lower end portion of the supply nozzle 11 forms a resin discharge unit. The resin discharge unit is coupled to the injection unit 2. The injection unit 2 includes a manifold 21 and a plurality of nozzles 22 disposed in a lower part of the manifold 21. The lower end portion of the supply nozzle 11 is coupled to the upper center of the manifold 21.

As illustrated in FIG. 2, the manifold 21 is a block-shaped or plate-shaped member that is coupled to the supply nozzle 11 of the material supply unit 1 and supplies the shaping material M supplied from the material supply unit 1 to each of the plurality of nozzles 22.

The manifold 21 is configured by a first member 6 and a second member 7 that can be assembled and separated. The first member 6 and the second member 7 are members separate from each other and are respectively formed of plate-shaped members. However, without being limited to this configuration, at least one of the first member 6 and the second member 7 may be configured by another form, for example, a block-shaped member.

The manifold 21 includes a main flow path 211 and a plurality of branch flow paths 212, in the present embodiment, four branch flow paths 212 branching from the main flow path 211. In the following explanation, the four branch flow paths 212 are also referred to as branch flow path 212A, branch flow path 212B, branch flow path 212C, and branch flow path 212D.

The main flow path 211 is formed in the first member 6. The main flow path 211 is a sprue extending in the z-axis direction. The upper end of the main flow path 211 is coupled to the lower end of the supply flow path 12 of the supply nozzle 11. Accordingly, the supply flow path 12 and the main flow path 211 communicate. The main flow path 211 is located at the center of the manifold 21 in plan view of the manifold 21, that is, when viewed in the z-axis direction.

The upper end of the main flow path 211 is opened on the + z axis side and the lower end of the main flow path 211 is located near the center of the manifold 21 in the thickness direction of the manifold 21, that is, the z axis direction of the manifold 21. The main flow path 211 is circular in a cross-sectional shape taken along an x-y plane. However, without being limited to this configuration, the cross-sectional shape of the main flow path 211 may be a shape other than the circular shape, for example, an elliptical shape, a rectangular shape, or another polygonal shape.

When the first member 6 and the second member 7 are joined on a lower surface 61 and an upper surface 71 thereof and assembled, the branch flow path 212A, the branch flow path 212B, the branch flow path 212C, and the branch flow path 212D are formed in a boundary portion 8 of the first member 6 and the second member 7. The branch flow path 212A, the branch flow path 212B, the branch flow path 212C, and the branch flow path 212D are runners radially branching at equal angular intervals (in the present embodiment, 90° intervals) from the lower end portion of the main flow path 211. The number of branch flow paths 212 is not limited to four. The disposition of the branch flow paths 212 may not be radial. Further, even when the plurality of branch flow paths 212 are radially disposed, the plurality of branch flow paths 212 may not branch at the equal angular intervals.

Each of the branch flow path 212A, the branch flow path 212B, the branch flow path 212C, and the branch flow path 212D includes a first portion 213 extending in the horizontal direction, that is, on a surface parallel to the x-y plane and a second portion 214 extending in the vertical direction, that is, the z-axis direction.

The first portion 213 is a portion radially branching centering on the main flow path 211. The second portion 214 extends downward in the vertical direction from the end portion on the far side of the first portion 213 from the main flow path 211.

The lengths of the first portions 213 in the branch flow path 212A, the branch flow path 212B, the branch flow path 212C, and the branch flow path 212D are equal. The lengths of the second portions 214 of the branch flow path 212A, the branch flow path 212B, the branch flow path 212C, and the branch flow path 212D are equal.

However, without being limited to this configuration, a part of the branch flow path 212A, the branch flow path 212B, the branch flow path 212C, and the branch flow path 212D may be different from the others in the length of the first portions 213 or may be different from the others in the length of the second portion 214.

The branch flow path 212A, the branch flow path 212B, the branch flow path 212C, and the branch flow path 212D each are circular in a cross-sectional shape of the flow paths. However, without being limited to this configuration, the cross-sectional shape of the main flow path 211 may be a shape other than the circular shape, for example, an elliptical shape, a rectangular shape, or another polygonal shape.

The branch flow path 212A, the branch flow path 212B, the branch flow path 212C, and the branch flow path 212D respectively fixed in inner diameters in the flow path longitudinal direction. The branch flow path 212A, the branch flow path 212B, the branch flow path 212C, and the branch flow path 212D are the same in inner diameters one another.

However, without being limited to this configuration, a part of the branch flow path 212A, the branch flow path 212B, the branch flow path 212C, and the branch flow path 212D may be different from the other in the inner diameter. The branch flow path 212A, the branch flow path 212B, the branch flow path 212C, and the branch flow path 212D may respectively have portions having different inner diameters.

As explained above, the branch flow path 212A, the branch flow path 212B, the branch flow path 212C, and the branch flow path 212D are radially disposed centering on the main flow path 211 when viewed in the extending direction of the main flow path 211. Accordingly, in the manifold 21, the branch flow path 212A, the branch flow path 212B, the branch flow path 212C, and the branch flow path 212D can be disposed to equally spread. Thus, the nozzles 22 can be installed in a well-balanced manner.

As illustrated in FIGS. 2 and 3, the manifold 21 includes a pair of installation holes 215 in which first heaters 216 are installed. The pair of installation holes 215 each extends in the x-axis direction. The pair of installation holes 215 is provided in parallel while being separated from each other in the y-axis direction. The first heaters 216 are formed in a long shape corresponding to the installation holes 215, respectively. The branch flow paths 212 are located between the pair of installation holes 215. That is, the branch flow path 212A, the branch flow path 212B, the branch flow path 212C, and the branch flow path 212D are located between a pair of the first heaters 216.

By the operation of the first heaters 216, substantially the entire manifold 21 can be heated and the shaping material M flowing through the main flow path 211, the branch flow path 212A, the branch flow path 212B, the branch flow path 212C, and the branch flow path 212D can be heated to a desired temperature. Thus, the viscosity, that is, the fluidity of the shaping material M can be maintained in a desired range, and the shaping material M can be satisfactorily and stably injected from the nozzles 22.

Since the branch flow path 212A, the branch flow path 212B, the branch flow path 212C, and the branch flow path 212D are located between the pair of first heaters 216, in particular, in the intermediate portion of the pair of first heaters 216, it is possible to equally heat the shaping material M in the branch flow path 212A, the branch flow path 212B, the branch flow path 212C, and the branch flow path 212D. As a result, injection of the shaping material M from the nozzles 22 (an injection nozzle 22A, an injection nozzle 22B, an injection nozzle 22C, and an injection nozzle 22D) can be more satisfactorily, uniformly, and stably performed.

As explained above, the manifold 21 includes the pair of first heaters 216 separated from each other. The branch flow path 212A, the branch flow path 212B, the branch flow path 212C, and the branch flow path 212D are located between the pair of first heaters 216. Accordingly, the shaping material M in the branch flow path 212A, the branch flow path 212B, the branch flow path 212C, and the branch flow path 212D can be equally heated. Thus, the injection of the shaping material M from the nozzles 22 can be more satisfactorily and more stably performed.

The first heaters 216 are electrically coupled to the control unit 5. Heating temperature of the first heaters 216 is set by the control unit 5 controlling a condition of energization to the first heaters 216.

The control unit 5 includes at least one processor, a storage unit, and the like. The processor reads a program stored in the storage unit and executes the program, whereby control explained in the present specification for the material supply unit 1, the injection unit 2, and the like is performed.

The manifold 21 includes a pressure detection unit 217. The pressure detection unit 217 includes a pressure sensor 217A, a pressure sensor 217B, a pressure sensor 217C, and a pressure sensor 217D. The pressure sensor 217A detects the pressure of the shaping material M flowing in the branch flow path 212A. The pressure sensor 217B detects the pressure of the shaping material M flowing in the branch flow path 212B. The pressure sensor 217C detects the pressure of the shaping material M flowing in the branch flow path 212C. The pressure sensor 217D detects the pressure of the shaping material M flowing in the branch flow path 212D.

The pressure sensor 217A, the pressure sensor 217B, the pressure sensor 217C, and the pressure sensor 217D are electrically coupled to the control unit 5. Information concerning the pressures detected by the pressure sensor 217A, the pressure sensor 217B, the pressure sensor 217C, and the pressure sensor 217D is transmitted to the control unit 5 as an electric signal. The information concerning the pressures can be used for monitoring of the units, for example, detection of a defect, and various controls in the injection molding machine 100. For example, when detection value of the pressure sensor 217A among the pressure sensor 217A, the pressure sensor 217B, the pressure sensor 217C, and the pressure sensor 217D deviates from a reference value, according to an alert of the deviation of the detection value, it is possible to determine whether the viscosity (the fluidity) of the shaping material M flowing through the branch flow path 212A and a flow rate relating to the viscosity are proper or improper. Further, based on this determination, it is possible to actuate a flow rate adjustment unit 218 explained below and change to thereby adjust the flow rate of the shaping material M flowing through the branch flow path 212A or adjust an output of a second heater 222 installed in the injection nozzle 22A to thereby change and adjust the temperature of the injection nozzle 22A. These kinds of control can be automatically performed by the control unit 5.

As explained above, the injection molding machine 100 includes the pressure detection unit 217 that detects the pressure of the shaping material M flowing through the branch flow path 212A, the branch flow path 212B, the branch flow path 212C, and the branch flow path 212D. When the number of the nozzles 22 in use is changed, the control unit 5 preferably controls the operation of the injection unit 2 to discard or wastefully inject the shaping material M until the pressure value measured by the pressure detection unit 217 becomes constant. Accordingly, the shaping material M can be injected into the die unit 3 in a state in which the pressure value is constant. Thus, it is possible to obtain a molded product that is more proper and suitable for a purpose and a molded product satisfying required quality. The discarding means that the nozzle 22 injects the shaping material M to a portion other than the die unit 3. For example, a discarding unit in which an operator discards the shaping material M is prepared and the discarding unit is disposed right under the nozzle 22 to perform the wasteful injection. When the pressure value measured by the pressure detection unit 217 becomes constant and the wasteful injection is completed, the discarding unit is removed and the shaping material M is injected to the die unit 3.

The manifold 21 includes the flow rate adjustment unit 218 that adjusts the flow rate of the shaping material M flowing through the branch flow path 212A, the branch flow path 212B, the branch flow path 212C, and the branch flow path 212D.

The flow rate adjustment unit 218 includes a plurality of, in the present embodiment, four insertion holes 219 and bar-shaped members 220 respectively inserted through the insertion holes 219.

The insertion holes 219 are respectively configured by holes extending in the z-axis direction and opened on a + z axis side surface of the manifold 21. The lower end portions of the insertion holes 219 communicate with a coupling portion 230 of the first portions 213 and the second portions 214 in the branch flow path 212A, the branch flow path 212B, the branch flow path 212C, and the branch flow path 212D.

The bar-shaped members 220 are configured to be capable of being inserted into and removed from the insertion hole 219. When the bar-shaped members 220 are inserted deepest toward the lower side, the lower end portions of the bar-shaped members s 220 can close the coupling portion 230 of the first portion 213 and the second portion 214 in the branch flow path 212A, the branch flow path 212B, the branch flow path 212C, and the branch flow path 212D and block all or a part of the flow paths. By adjusting the insertion depth of the bar-shaped members 220, an effective cross-sectional area of the coupling portion 230 of the first portions 213 and the second portions 214 can be increased or decreased. Thus, the flow rate of the shaping material M flowing through the branch flow path 212A, the branch flow path 212B, the branch flow path 212C, and the branch flow path 212D can be adjusted.

Up-down movements of the bar-shaped members 220 with respect to the insertion holes 219 can be performed in association with one another and can be performed independently of one another. In the latter case, the flow rate of the shaping material M can be adjusted for each of the branch flow path 212A, the branch flow path 212B, the branch flow path 212C, and the branch flow path 212D. For example, when a detection value of the pressure sensor 217A among the pressure sensor 217A, the pressure sensor 217B, the pressure sensor 217C, and the pressure sensor 217D deviates from the reference value, the flow rate of the shaping material M flowing through the branch flow path 212A can be changed and adjusted by raising or lowering the bar-shaped member 220 corresponding to the branch flow path 212A.

The up-down movements of the bar-shaped members 220 can be performed by driving a not-illustrated drive source such as a motor. The drive source is electrically coupled to the control unit 5. The control unit 5 performs drive control of the drive source.

As explained above, the manifold 21 includes the flow rate adjustment unit 218 that adjusts the flow rate of the shaping material M flowing through the branch flow path 212A, the branch flow path 212B, the branch flow path 212C, and the branch flow path 212D. It is preferable that the control unit 5 controls the operation of the flow rate adjustment unit 218 to close the nozzle 22 not in use among the plurality of nozzles 22. Accordingly, operation such as attachment and detachment of the nozzles 22 can be omitted and the shaping material M can be supplied only to the nozzles 22 used according to the shape of the die unit 3. Thus, it is possible to obtain a molded product that is more proper and suitable for a purpose and a molded product satisfying required quality.

The configuration including the four insertion holes 219 and the bar-shaped members 220 inserted through the insertion holes 219 is explained as the flow rate adjustment unit 218. However, the present disclosure is not limited to this and the flow rate adjustment unit 218 may be configured by, for example, valves that adjust opening degrees of the branch flow path 212A, the branch flow path 212B, the branch flow path 212C, and the branch flow path 212D.

As illustrated in FIGS. 2 and 3, the plurality of nozzles 22, in the present embodiment, the four nozzles 22 are installed on the lower end surface, that is, the − z-axis side surface of the manifold 21. The nozzles 22 are respectively coupled to the second portions 214 of the branch flow path 212A, the branch flow path 212B, the branch flow path 212C, and the branch flow path 212D corresponding thereto. The nozzles 22 include internal flow paths 221. The internal flow paths 221 respectively communicate with the branch flow path 212A, the branch flow path 212B, the branch flow path 212C, and the branch flow path 212D.

In the following explanation, the nozzle 22 coupled to the second portion 214 of the branch flow path 212A is referred to as injection nozzle 22A, the nozzle 22 coupled to the second portion 214 of the branch flow path 212B is referred to as injection nozzle 22B, the nozzle 22 coupled to the second portion 214 of the branch flow path 212C is referred to as injection nozzle 22C, and the nozzle 22 coupled to the second portion 214 of the branch flow path 212D is referred to as injection nozzle 22D.

The injection nozzle 22A, the injection nozzle 22B, the injection nozzle 22C, and the injection nozzle 22D respectively include second heaters 222 that heat the nozzles. The shaping material M passing through the internal flow paths 221 can be heated by operation of the second heaters 222. Thus, the viscosity (the fluidity) of the shaping material M can be kept in a desired range and the injection of the shaping material M from the nozzles 22 can be satisfactorily and stably performed.

The second heaters 222 are embedded in parallel to the internal flow paths 221 at positions different from the positions of the internal flow paths 221. That is, the second heaters 222 are bar-shaped heaters formed in a bar shape. Accordingly, the shaping material M passing through the internal flow paths 221 can be more uniformly and efficiently heated.

The second heaters 222 are electrically coupled to the control unit 5. Heating temperature of the second heaters 222 can be set by the control unit 5 controlling a condition of energization to the second heaters 222.

The second heaters 222 are not limited to the bar-shaped heaters as in the present embodiment and may be, for example, coil-shaped heaters disposed on the outer peripheries of the nozzles 22.

As explained above, the nozzles 22 include the second heaters 222 that heat the nozzles 22. Accordingly, it is possible to prevent temperature drop of the shaping material M injected from the nozzles 22 and keep the viscosity (the fluidity) of the shaping material M in a desired range. As a result, the shaping material M can be satisfactorily and stably injected from the nozzles 22.

In the present embodiment, the second heaters 222 are respectively installed in all the nozzles 22, that is, the injection nozzle 22A, the injection nozzle 22B, the injection nozzle 22C, and the injection nozzle 22D. However, not only this, but the second heaters 222 may be installed in only a part of all the nozzles 22.

The nozzles 22 include temperature sensors 223 that detect the temperature of the shaping material M in the nozzles 22. The temperature sensors 223 are each electrically coupled to the control unit 5. Information concerning temperatures detected by the temperature sensors 223 is transmitted to the control unit 5 as an electric signal. Accordingly, based on detection values of the temperature sensors 223, the control unit 5 can control the operation of the second heaters 222 corresponding to the temperature sensors 223 or control the operation of the first heaters 216 corresponding to the temperature sensors 223. Thus, the temperature of the shaping material M injected from the nozzles 22 can be adjusted or maintained within a desired range. As a result, the quality of a molded product obtained by the injection molding machine 100 can be improved.

In the present embodiment, the temperature sensors 223 can continuously, intermittently, or stepwise detect the temperature of the nozzles 22 or the shaping material M in the nozzles 22. However, the present disclosure is not limited to this and the temperature sensors 223 may be configured by mere thermocouples. For example, a predetermined reference temperature may be set and it may be detected whether the reference temperature has been exceeded.

As explained above, the nozzles 22 include the temperature sensors 223 that detect the temperature of the shaping material M in the nozzles 22. Accordingly, for example, based on detection values of the temperature sensors 223, the operation of the second heaters 222, the first heaters 216, or the like corresponding to the temperature sensors 223 can be controlled. Thus, the temperature of the shaping material M injected from the nozzles 22 can be adjusted or maintained within a desired range.

It is preferable that the control unit 5 controls the operation of the second heaters 222 based on the detection values of the temperature sensors 223 and adjust the flow rate of the shaping material M injected from the plurality of nozzles 22. Accordingly, the shaping material M can be accurately injected from the nozzles 22 taking into account a change in the flow rate of the shaping material M due to a temperature change.

In the present embodiment, the temperature sensors 223 are respectively installed in all of the nozzles 22, that is, the injection nozzle 22A, the injection nozzle 22B, the injection nozzle 22C, and the injection nozzle 22D. However, not only this, but the temperature sensors 223 may be installed only a part of all the nozzles 22 among all the nozzles 22.

The die unit 3 illustrated in FIG. 1 has a not-illustrated molding die, in particular, a die in which a cavity corresponding to the shape of a target molded product is formed. The shaping material M injected from the nozzles 22 of the injection unit 2 is supplied to and filled in the cavity. Thereafter, the shaping material M is cooled and solidified and a molded product is generated.

Four cavities of the molding die may be formed respectively for the injection nozzle 22A, the injection nozzle 22B, the injection nozzle 22C, and the injection nozzle 22D or the cavity may be formed in common in two or more of the injection nozzle 22A, the injection nozzle 22B, the injection nozzle 22C, and the injection nozzle 22D.

The positioning unit 4 performs positioning of the injection unit 2 and the die unit 3 and fixes the injection unit 2 and the die unit 3. The positioning unit 4 is formed in a block shape and includes through holes into which the nozzles 22 are respectively inserted. Although not illustrated, the positioning unit 4 includes fixing means capable of selecting fixing and release of the fixing of the injection unit 2 and the die unit 3. Accordingly, the positional accuracy of the nozzles 22 with respect to the die unit 3 can be improved and the nozzle 22 can stably inject the shaping material M.

As explained above, the manifold 21 is configured by the first member 6 and the second member 7 that can be assembled and separated. The first member 6 and the second member 7 are members separate from each other and are respectively formed of plate-shaped members. However, without being limited to this configuration, at least one of the first member 6 and the second member 7 may be configured by another form, for example, a block-shaped member.

In an assembled state in which the first member 6 and the second member 7 are assembled (hereinafter sometimes simply referred to as “assembled state”), as illustrated in FIGS. 3 and 4, the first member 6 and the second member 7 are superimposed with their thickness direction along the z-axis. In the assembled state, the first member 6 is located on the + z axis side, the second member 7 is located on the − z axis side, and the lower surface 61 of the first member 6 and the upper surface 71 of the second member 7 are joined. In the assembled state, the material supply unit 1 is coupled to the first member 6 and the nozzles 22 are coupled to the second member 7.

The first member 6 and the second member 7 have the same thickness (average thickness) in the illustrated configuration. However, the present disclosure is not limited to this and the thicknesses of the first member 6 and the second member 7 may be different.

In the assembled state of the first member 6 and the second member 7, the first member 6 and the second member 7 are fixed such that the joined state, that is, the assembled state of the first member 6 and the second member 7 is maintained. The maintenance and fixing of the assembled state can be performed by a not-illustrated fixing member. By releasing the fixing by the fixing member, as illustrated in FIG. 4, the assembled state of the first member 6 and the second member 7 can be released, and the first member 6 and the second member 7 can be separated, that is, changed to a separated state.

The fixing member is not particularly limited. Examples of the fixing member include a clamping member such as a clamp that clamps two sides located on the − x-axis side and the + x-axis side or two sides located on the − y-axis side and the + y-axis side among four sides of the outer peripheral portions (the edge portions) of the first member 6 and the second member 7 illustrated in FIG. 2. Such a fixing member is preferably a member that is detachably attachable to the first member 6 and the second member 7 and can easily perform the fixing and release of the first member 6 and the second member 7.

The first member 6 includes the main flow path 211 penetrating the first member 6 in the thickness direction thereof (the z-axis direction), a plurality of first grooves 62 extending to be orthogonal to the main flow path 211 on the x-y plane and communicating with the lower end of the main flow path 211 and opened on the lower surface 61 (the surface facing the second member 7 on the − z axis side) of the first member 6, and a plurality of installation grooves 63 opened on the lower surface 61.

The first grooves 62 are semicircular in a cross-sectional shape and four first grooves 62 are formed. In the assembled state, the first grooves 62 are parts configuring the branch flow path 212A, the branch flow path 212B, the branch flow path 212C, and the branch flow path 212D explained above. The positions where the first grooves 62 are formed and the shape of the first grooves 62 viewed in the z-axis direction are as explained above.

The installation grooves 63 are semicircular in a cross-sectional shape and two installation grooves 63 are formed. A pair of installation grooves 63 are parts to be a pair of installation holes 215 in which the first heaters 216 explained above are installed. The positions where the pair of installation grooves 63 is formed and the shape of the pair of installation grooves 63 viewed in the z-axis direction are as explained above.

The second member 7 includes a plurality of second grooves 72 opened on the upper surface 71 (the surface facing the first member 6 on the + z axis side) of the second member 7, a plurality of installation grooves 73 opened on the upper surface 71, and the second portions 214 explained above.

The second grooves 72 are semicircular in a cross-sectional shape and four second grooves 72 are formed. The second grooves 72 are parts configuring, in conjunction with the first grooves 62 corresponding thereto formed in the first member 6, the branch flow path 212A, the branch flow path 212B, the branch flow path 212C, and the branch flow path 212D explained above in the assembled state. The positions where the second grooves 72 are formed and the shape of the second grooves 72 viewed in the z-axis direction are as explained above.

The installation grooves 73 are semicircular in a cross-sectional view and two installation grooves 73 are formed. The pair of installation grooves 73 is parts configuring, in conjunction with the installation grooves 63 of the first member 6, a pair of installation holes 215 in which the first heaters 216 explained above are installed. The positions where the pair of installation grooves 73 are formed and the shape of the pair of installation grooves 73 viewed in the z-axis direction are as explained above.

When the first member 6 and the second member 7 are assembled, the first grooves 62 and second grooves 72 corresponding to each other are combined and overlap in the z-axis direction to form the first portions 213 of the branch flow path 212A, the branch flow path 212B, the branch flow path 212C, and the branch flow path 212D.

When the first member 6 and the second member 7 are separated, the plurality of first grooves 62 opened on the lower surface 61 of the first member 6 are exposed and the plurality of second grooves 72 opened on the upper surface 71 of the second member 7 are exposed. In the separated state, since the first grooves 62 and the second grooves 72 are exposed, maintenance such as cleaning of the first grooves 62 and the second grooves 72, more specifically, maintenance such as maintenance, inspection, cleaning, and polishing of the branch flow paths 212 and replacement of all or a part of components (hereinafter sometimes simply referred to as “maintenance”) can be easily performed.

More specifically, in the assembled state of the first member 6 and the second member 7, the branch flow path 212A, the branch flow path 212B, the branch flow path 212C, and the branch flow path 212D are formed in the boundary portion 8 of the first member 6 and the second member 7, that is, on a joining surface 81 of the lower surface 61 of the first member 6 and the upper surface 71 of the second member 7 (a virtual surface in a state in which the lower surface 61 and the upper surface 71 are joined). The plasticized shaping material M supplied from the material supply unit 1 can be guided to the internal flow paths 221 of the nozzles 22 through the supply flow path 12, the main flow path 211, and the branch flow paths 212 and injected from the lower ends of the nozzles 22.

On the other hand, when the first member 6 and the second member 7 are separated, the first grooves 62 and the second grooves 72 are exposed and the branch flow path 212A, the branch flow path 212B, the branch flow path 212C, and the branch flow path 212D are opened. Therefore, maintenance of the branch flow paths 212 and the peripheries thereof, other parts, and the like can be easily performed. Thus, for example, it is possible to prevent a defect of, for example, clogging or the like occurring in a part of the branch flow paths 212 and hindering a smooth flow of the shaping material M, and continuously perform satisfactory and stable injection of the shaping material M. As a result, the quality (molding quality) of the molded product obtained by the injection molding machine 100 can be kept satisfactory.

In the separated state, the installation grooves 63 and the installation grooves 73 are exposed and the installation holes 215 are opened. Therefore, attachment and detachment of the first heaters 216 to and from the installation holes 215 and maintenance such as cleaning and replacement of the first heaters 216 can be easily performed.

As explained above, in the assembled state, the first grooves 62 and the second grooves 72 corresponding to each other are combined and the first portions 213 of the branch flow paths 212 are formed. In this case, in the present embodiment, each of the first groove 62 and the second groove 72 bears a half of the volume of the flow path of the first portion 213. That is, a volume ratio of the first groove 62 and the second groove 72 is 1:1. However, in the present disclosure, the volume ratio of the flow path of the first portion 213 formed by the first groove 62 and the second groove 72 can take any value of 1:100 to 100:1. That is, the first portion 213 may be formed unevenly on the side of one of the first member 6 and the second member 7.

A constituent material of the first member 6 and the second member 7 is not particularly limited. Examples of the constituent material include various metal materials such as an iron-based alloy such as pre-hard steel, as-rolled steel, and stainless steel, aluminum or an aluminum alloy, or copper or a copper-based alloy, and various ceramic materials. When the first member 6 and the second member 7 are made of a metal material, the metal material may be the same as or may be different from the material of the die of the die unit 3 explained above.

As explained above, the injection molding machine 100 includes the material supply unit 1 that supplies the shaping material M including the plasticized thermoplastic resin, the injection unit 2 including the manifold 21 including the main flow path 211 communicating with the material supply unit 1 and the plurality of branch flow paths 212 branching from the main flow path 211 and the plurality of nozzles 22 that are respectively coupled to the branch flow paths 212 and inject the shaping material M to the die unit 3, the positioning unit 4 that positions the injection unit 2 and the die unit 3, and the control unit 5 that controls the operation of the material supply unit 1 and the injection unit 2. The manifold 21 includes the first member 6 and the second member 7 that are the bodies separate from each other and can be assembled and separated. The branch flow paths 212 are formed in the boundary portion 8 (the joining surface 81) of the first member 6 and the second member 7 in the assembled state of the first member 6 and the second member 7. Accordingly, when the first member 6 and the second member 7 are assembled, the plasticized shaping material M can be transferred to the nozzles 22 via the main flow path 211 and the branch flow paths 212 and injected. On the other hand, by separating the first member 6 and the second member 7, maintenance of the branch flow paths 212 and the like can be easily performed. Thus, it is possible to prevent a defect of, for example, clogging or the like occurring in a part of the branch flow paths 212 and hindering a smooth flow of the shaping material M and continuously perform satisfactory and stable injection of the shaping material M. As a result, the quality of a molded product obtained by the injection molding machine 100 can be maintained satisfactory.

As explained above, the first portion 213 of the branch flow path 212 formed in the assembled state is shared at a ratio of ½ or a ratio other than ½ by each of the first groove 62 formed in the first member 6 and the second groove 72 formed in the second member 7. That is, in the present embodiment, elements to be the branch flow paths 212 are formed in both the first member 6 and the second member 7. However, the present disclosure is not limited to this. The first portions 213 of the branch flow paths 212 may be formed only in one of the first member 6 and the second member 7. That is, the first groove may be formed only in the first member 6 and the second groove may not be formed in the second member 7 or the second groove may be formed only in the second member 7 and the first groove may not be formed in the first member 6.

The number, a disposition form, and the like of the branch flow paths 212 are not limited to the illustrated configuration.

The first member 6 and the second member 7 are respectively formed in plate shapes and are superimposed in a direction in which the thickness directions thereof coincide with each other in an assembled state. Accordingly, assembly and separation of the first member 6 and the second member 7 can be easily performed and maintenance can be more easily performed.

The first member 6 includes the first grooves 62 opened in the boundary portion 8 (the lower surface 61), the second member 7 includes the second grooves 72 opened in the boundary portion 8 (the upper surface 71), and the branch flow paths 212 are formed in the first grooves 62 and the second grooves 72 in the assembled state. Accordingly, the cross-sectional area of the branch flow paths 212 can be increased as much as possible and maintenance can be more easily performed.

The injection molding machine of the present disclosure is explained above based on the illustrated embodiment. However, the present disclosure is not limited to this and the components of the units can be substituted with any components having the same functions. Any other constituent objects may be added.

The injection molding machine may include a weight detection unit that detects the weight of the shaping material M supplied to the die unit 3. In this case, the control unit 5 can control the operation of the injection unit 2 based on a detection value of the weight detection unit such that an injection amount of the shaping material M from the nozzle 22 becomes constant.

The nozzles 22 may include branch flow paths or members including branch flow paths may be attached to the nozzles 22.

The manifold 21 may include a plurality of main flow paths. In this case, branch flow paths branching from the main flow paths may communicate with one another or may be independently provided.

What is claimed is:

1. An injection molding machine comprising:
a material supply unit configured to supply a shaping material including plasticized thermoplastic resin;
an injection unit including a manifold including a main flow path communicating with the material supply unit and a plurality of branch flow paths branching from the main flow path, and a plurality of nozzles respectively coupled to the branch flow paths and configured to inject the shaping material to a die unit;
a positioning unit configured to position the injection unit and the die unit; and
a control unit configured to control operation of the material supply unit and the injection unit, wherein
the manifold includes a first member and a second member that are bodies separate from each other and can be assembled and separated, and
the branch flow paths are formed in a boundary portion of the first member and the second member in an assembled state of the first member and the second member.

2. The injection molding machine according to claim 1, wherein the first member and the second member are respectively formed in plate shapes and are superimposed in a direction in which thickness directions thereof coincides in the assembled state.

3. The injection molding machine according to claim 1, wherein
the first member includes a first groove opened in the boundary portion,
the second member includes a second groove opened in the boundary portion, and
the branch flow paths are formed by the first groove and the second groove in the assembled state.

4. The injection molding machine according to claim 1, wherein the branch flow paths are radially disposed centering on the main flow path when viewed in an extending direction of the main flow path.

5. The injection molding machine according to claim 1, wherein
the manifold includes a pair of first heaters provided while being separated from each other, and
the branch flow paths are located between the pair of first heaters.

6. The injection molding machine according to claim 1, further comprising a flow rate adjustment unit configured to adjust a flow rate of the shaping material flowing through the branch flow paths, wherein
the control unit controls operation of the flow rate adjustment unit to close the nozzle not in use among the plurality of nozzles.

7. The injection molding machine according to claim 1, further comprising a pressure detection unit configured to detect pressure of the shaping material flowing through the branch flow paths, wherein
when a number of the nozzles in use is changed, the control unit controls the operation of the injection unit to wastefully inject the shaping material until a pressure value measured by the pressure detection unit becomes constant.

8. The injection molding machine according to claim 1, further comprising a temperature sensor configured to detect temperature of the shaping material in the nozzles and a second heater configured to heat the nozzles, wherein
the control unit controls operation of the second heater based on a detection value of the temperature sensor to adjust temperature of the shaping material injected from the plurality of nozzles.
